(19) United States
(12) Patent Application Publication
(10) Pub. No.: US 2013/0198415 A1
(43) Pub. Date: Aug. 1, 2013

(54) CONTROLLER AND DEVICE

(71) Applicants: Yuuichi Abe, Ome-shi (JP); Masaki Obuchi, Ome-shi (JP); Masashi Sakamoto, Ome-shi (JP)

(72) Inventors: Yuuichi Abe, Ome-shi (JP); Masaki Obuchi, Ome-shi (JP); Masashi Sakamoto, Ome-shi (JP)

(73) Assignee: Kabushiki Kaisha Toshiba, Tokyo (JP)

(21) Appl. No.: 13/467,855

(22) Filed: May 9, 2012

(30) Foreign Application Priority Data
Jan. 27, 2012 (JP) 2012-015116

(51) Int. Cl. G06F 3/00

(52) U.S. Cl. 710/5

(57) ABSTRACT

According to one embodiment, controller and a device includes A controller includes: a command completion recognizer 33 recognizes that an SDB FIS can be sent after the completion of data transfer according to the FPDMA command between a host apparatus and the same; an R_RDY response suppressing control signal generator 35 generates an R_RDY response suppressing control signal based on a recognition result from the command completion recognizer; an R_RDY response suppresser 41 suppresses an R_RDY response with respect to X_RDY received from the host apparatus in response to the R_RDY response suppressing control signal; and an SDB FIS sender 34 sends an SDB FIS to the host apparatus after the R_RDY response suppression control.

### CROSS-REFERENCE TO RELATED APPLICATIONS

This application is based upon and claims the benefit of priority from Japanese Patent Application No. 2012-015116, filed on Jan. 27, 2012; the entire contents of which are incorporated herein by reference.

### FIELD

Embodiments described herein relate generally to a controller and a device.

### BACKGROUND

In the SATA (Serial ATA (Advanced Technology Attachment)) protocol, in the case where a command is completed after the completion of data transfer according to an FPDMA (First Party Direct Memory Access) command, a device has sent an SDB (Set Device Bits) FIS (Frame Information Structure) to a host apparatus during the period of no data transfer. On the other hand, in the case where the host apparatus wants to issue a next FPDMA command, it sends a RegH2D FIS to the device during the period of no data transfer. If it is determined that the host apparatus completes preparing to issue a next command whereas the device can complete the current command during the data transfer, the RegH2D FIS from the host apparatus may possibly collide with the SDB FIS from the device immediately after the completion of the data transfer. In the case of the occurrence of a collision, an FIS of the host apparatus or the device that has been resumed to send earlier becomes valid, thereby discarding an FIS of the device or the host apparatus that was to send the FIS later.

However, in the case where the collision occurs in the related art, there may occur a situation in which the device cannot complete the command because the SDB FIS sent is discarded as a result of the collision with the RegH2D FIS from the host apparatus. In this case, although a controller in the device performs command completion processing by FW (Firm Ware), processing by HW (Hard Ware) for the purpose of the completion of the command is cancelled due to the collision with the host apparatus, thereby raising a problem of the need to perform complicated processing by an additional HW operation.

### BRIEF DESCRIPTION OF THE DRAWINGS

FIG. 1 is a diagram illustrating a constitutional example of an HDD in a first embodiment;

FIG. 2 is a diagram illustrating a constitutional example of an HDC unit in the first embodiment;

FIG. 3 is a diagram illustrating a constitutional example of a SATA transfer controller;

FIG. 4 is a diagram illustrating an FIS that is transmitted or received during data transfer according to an FPDMA command;

FIG. 5 is a diagram illustrating the processing till an R_RDY response suppressing control in which an R_RDY response is suppressed with respect to X_RDY from a host apparatus by a device;

FIG. 6 is a diagram illustrating a constitutional example of an SSD in a second embodiment; and

FIG. 7 is a diagram illustrating a constitutional example of an SSDC unit in the second embodiment.

### DETAILED DESCRIPTION

In general, according to one embodiment, controller and a device includes A controller of a embodiment according to the present invention includes: a command completion recognizer recognizes that an SDB FIS for completing an FPDMA command being executed can be sent after the completion of data transfer currently executed in response to the FPDMA command between a host apparatus and the same; an R_RDY response suppressing control signal generator generates and output an R_RDY response suppressing control signal for suppressing an R_RDY response with respect to X_RDY received from the host apparatus after the completion of the data transfer based on a recognition result from the command completion recognizer; an R_RDY response suppresser performs an R_RDY response suppression control for suppressing an R_RDY response with respect to X_RDY received from the host apparatus upon receipt of the R_RDY response suppressing control signal; and an SDB FIS sender sends an SDB FIS to the host apparatus after the R_RDY response suppression control.

Exemplary embodiments of controller and a device will be explained below in detail with reference to the accompanying drawings. The present invention is not limited to the following embodiments.

### First Embodiment

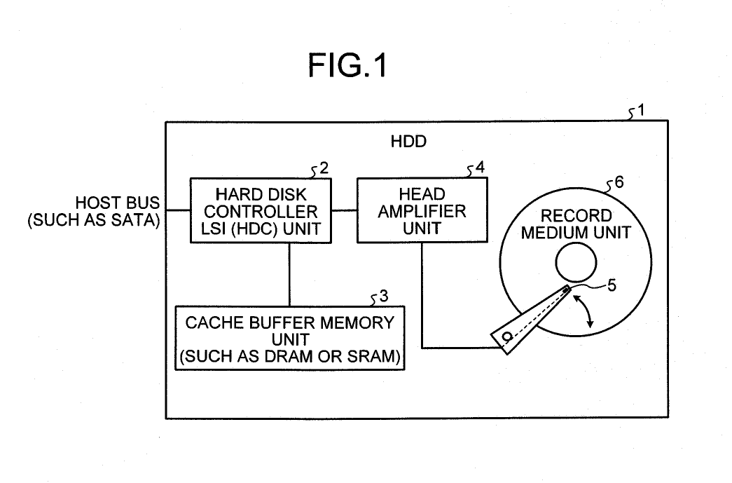

FIG. 1 is a diagram illustrating a constitutional example of an HDD (Hard Disk Drive) capable of transmitting and receiving data as one example of a device of the SATA in a first embodiment. An HDD 1 includes a hard disk controller LSI (Large Scale Integrated circuit) (hereinafter referred to as an “HDC”) unit 2, a cache buffer memory unit 3, a head amplifier unit 4, a Read/Write head unit 5, and a record medium unit 6.

The HDC unit 2 is a controller (a control unit) for controlling a device (the HDD 1) and is connected to a host apparatus (not illustrated) via a host bus such as the SATA.

The cache buffer memory unit 3 stores therein data or the like read by the HDC unit 2. The cache buffer memory unit 3 may be a DRAM or an SRAM but is not limited to them.

The head amplifier unit 4 is adapted to amplify a signal (data) read by the Read/Write head unit 5.

The Read/Write head unit 5 is held by an arm and scans the record medium unit 6 so as to read and write the data. The Read/Write head unit 5 can be moved in a radial direction of the record medium unit 6 on a shaft to which the arm is fixed.

The record medium unit 6 has a data area in which the Read/Write head unit 5 can read and write data.

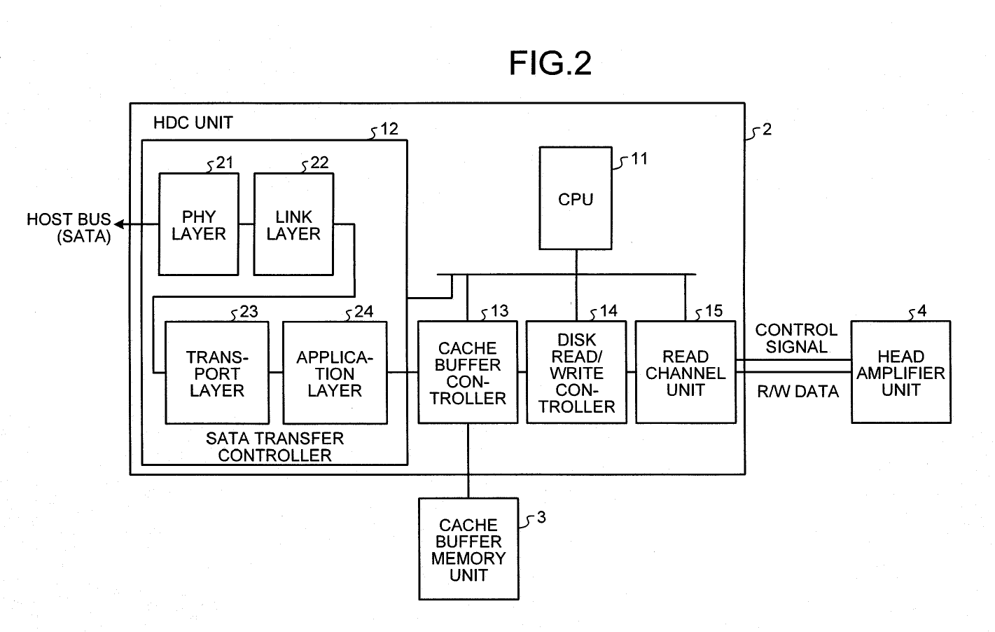

FIG. 2 is a diagram illustrating a constitutional example of the HDC unit 2 according to the first embodiment. The HDC unit 2 includes a CPU (Central Processing Unit) 11, a SATA transfer controller 12, a cache buffer controller 13, a disk read/write controller 14, and a Read Channel unit 15.

The CPU 11 controls the entire HDD 1.

The SATA transfer controller 12 includes a PHY Layer 21, a Link Layer 22, a Transport Layer 23, and an Application Layer 24 and performs an interface control with respect to the host apparatus. The details will be described later.

The cache buffer controller 13 is adapted to control the cache buffer memory unit 3. Specifically, data read by the Read Channel unit 15 is acquired through the disk read/write controller 14, is stored in the cache buffer memory unit 3, and then, is transferred to the SATA transfer controller 12.

The disk read/write controller 14 and the Read Channel unit 15 output a control signal required for positioning the Read/Write head unit 5, and further, process Read/Write data for reading and writing data from and in the record medium unit 6.

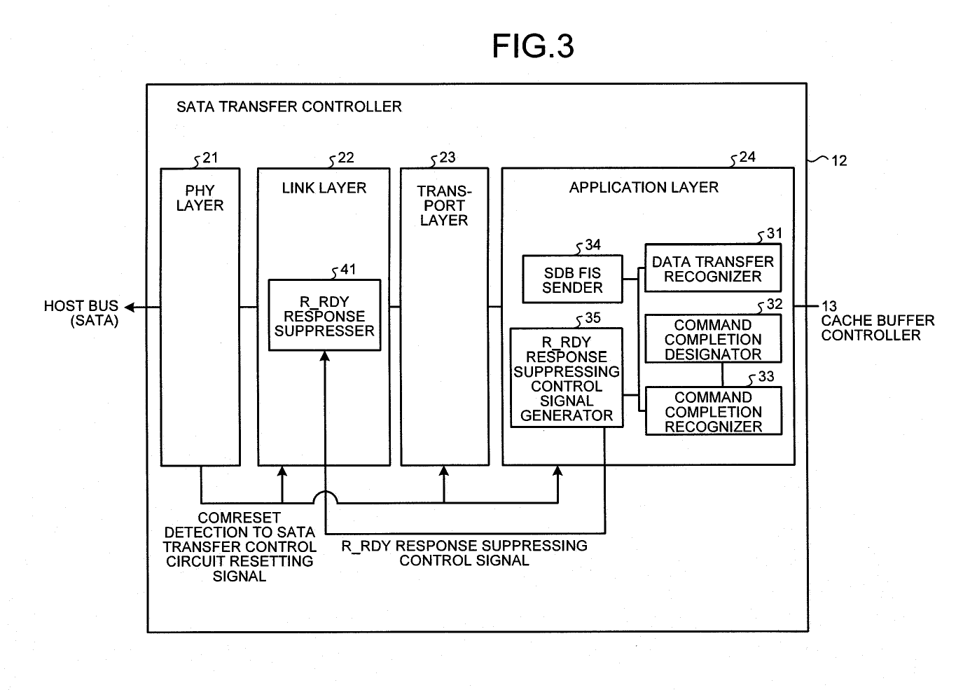

FIG. 3 is a diagram illustrating a constitutional example of the SATA transfer controller 12. The SATA transfer controller 12 includes: the PHY Layer 21, as an interface in the SATA, for transmitting and receiving the data to and from the host apparatus; the Link Layer 22, in the SATA, for converting 8 bit/10 bit, interpreting, assembling, and sending a primitive, and controlling power management; the Transport Layer 23 for controlling decomposition and formation of the FIS; and the Application Layer 24, in the SATA, for interpreting command data, interpreting, assembling, and sending the FIS, and controlling data transfer.

Moreover, the Application Layer 24 includes a data transfer recognizer 31, a command completion designator 32, a command completion recognizer 33, an SDB FIS sender 34, and an R_RDY response suppressing control signal generator 35.

The data transfer recognizer 31 is designed to recognize that its own apparatus (the HDD 1) is transferring data according to an FPDMA command during the continuation of the data transfer according to the FPDMA command.

Before the completion of the data transfer, the command completion designator 32 notifies the command completion recognizer 33 of an indication that the FPDMA command currently executed may be completed upon the completion of the data transfer currently executed.

The command completion recognizer 33 is adapted to recognize that the FPDMA command currently executed may be completed, that is, the SDB FIS may be sent upon the completion of the data transfer currently executed when it is notified by the command completion designator 32.

The SDB FIS sender 34 sends the SDB FIS to the host apparatus after the completion of the data transfer based on the recognition results from the data transfer recognizer 31 and the command completion recognizer 33.

The R_RDY response suppressing control signal generator 35 generates an R_RDY response suppressing control signal based on the recognition results from the data transfer recognizer 31 and the command completion recognizer 33.

In the meantime, the Link Layer 22 includes an R_RDY response suppresser 41.

The R_RDY response suppresser 41 controls R_RDY response suppression in response to the R_RDY response suppressing control signal.

Subsequently, a description will be given of processing for completing the command by securely sending the SDB FIS to the host apparatus after the data transfer in response to the FPDMA command in the HDD 1. A description will be given on an example of the FPDMA command (a WRITE FPDMA QUEUED command) when the HDD 1 receives (writes) data.

First, the data transfer recognizer 31 in the Application Layer 24 recognizes the data transfer according to the FPDMA command during the continuation of the data transfer according to the FPDMA command.

Before the completion of the data transfer, the command completion designator 32 notifies the command completion recognizer 33 of the indication that the FPDMA command currently executed may be completed upon the completion of the data transfer currently executed. In the actual HDD 1, the indication herein means a notification from FW to HW.

The command completion recognizer 33 recognizes that the FPDMA command currently executed may be completed, that is, the SDB FIS may be sent upon the completion of the data transfer currently executed when it is notified by the command completion designator 32.

The SDB FIS sender 34 sends the SDB FIS to the host apparatus after the completion of the data transfer based on the recognition results from the data transfer recognizer 31 and the command completion recognizer 33 upon the completion of the data transfer currently executed.

The R_RDY response suppressing control signal generator 35 generates the R_RDY response suppressing control signal based on the recognition results from the data transfer recognizer 31 and the command completion recognizer 33 before the SDB FIS is sent, specifically, at the time of the recognition of the completion of the data transfer in the data transfer recognizer 31, after the completion of the data transfer by the SDB FIS sender 34, and then, outputs the R_RDY response suppressing control signal to the Link Layer 22.

In the Link Layer 22, when the R_RDY response suppresser 41 receives the R_RDY response suppressing control signal, it controls R_RDY response suppression to prevent any R_RDY response even if X_RDY to be sent before the issue of a next FPDMA command is received from the host apparatus. Specifically, the R_RDY response suppresser 41 does not perform the R_RDY response even if X_RDY is received from the host apparatus until the SDB FIS sender 34 completes sending the SDB FIS in the Application Layer 24.

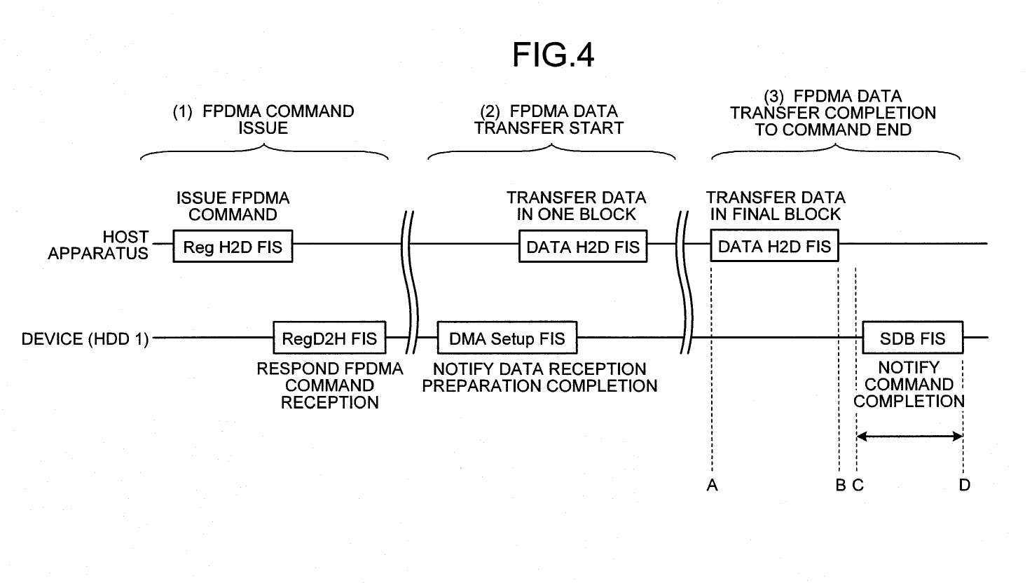

Here, a description will be given of the FIS to be transmitted and received when the data is transferred between the host apparatus and the device (the HDD 1) according to the FPDMA command. FIG. 4 is a diagram illustrating the FIS that is transmitted and received during the data transfer according to the FPDMA command.

(1) During the issue of the FPDMA command, the host apparatus sends, to the device (the HDD 1), a RegH2D FIS for use in issuing the FPDMA command, and then, the device (the HDD 1) sends the RegD2H FIS for responding the reception of the FPDMA command under the control of the Application Layer 24.

(2) At the beginning of the FPDMA data transfer, the device (the HDD 1) sends a DMA Setup FIS for notifying the data reception preparation completion to the host apparatus under the control of the Application Layer 24 whereas the host apparatus sends, to the device (the HDD 1), a Data H2D FIS for transferring data stored in a first block out of a plurality of blocks divided. After that, the host apparatus continues to send the Data H2D FIS for transferring the data to the device (the HDD 1).

(3) After the completion of the FPDMA data transfer until the completion of the command, the host apparatus sends, to the device (the HDD 1), the Data H2D FIS for transferring data stored in a final block out of the plurality of blocks divided. In contrast, the device (the HDD 1) sends the SDB FIS for completing the command under the control of the Application Layer 24.

In FIG. 4, when the host apparatus sends X_RDY for the next FPDMA command until the device (the HDD 1) sends the SDB FIS, the device (the HDD 1) has made an R_RDY response in the related art, and therefore, the SDB FIS cannot be sent, resulting in the state in which the command cannot be completed. Hence, it is found (recognized) that the device (the HDD 1) can complete the FPDMA command (send the SDB FIS) upon the completion of the data transfer currently executed at a timing A in FIG. 4 in the Application Layer 24. As a consequence, after the host apparatus sends the Data H2D FIS for transferring the data in the final block (at a timing B in FIG. 4), the device (the HDD 1) controls to prevent an R_RDY response to X_RDY from the host apparatus with respect to the Link Layer 22 after the Application Layer 24 confirms (at a timing C in FIG. 4) that the Link Layer 22 normally receives the data until the Application Layer 24 completes sending the SDB FIS (at a timing D in FIG. 4).

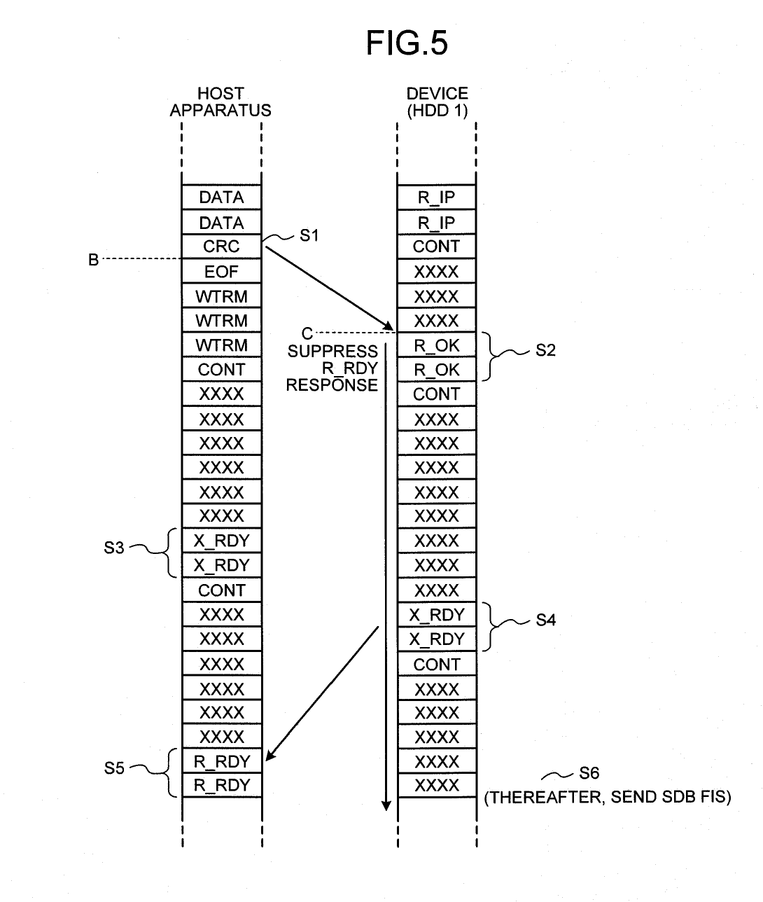

A description will be given in detail of processing until the control in which the device (the HDD 1) does not make any R_RDY response to X_RDY from the host apparatus. FIG. 5 is a diagram illustrating the processing till an R_RDY response suppressing control in which the R_RDY response is suppressed against X_RDY from the host apparatus by the device (the HDD 1).

When the host apparatus sends final data whose end has a CRC (Cyclic Redundancy Check) attached thereto (step S1), the device (the HDD 1) makes a CRC check. When the CRC check results in no error, the device (the HDD 1) returns to R_OK. At this timing, the device (the HDD 1) establishes the condition that the data transfer (reception) can be normally completed (the SDB FIS can be transmitted) (step S2). Hence, the device (the HDD 1) starts the response suppressing control in which the R_RDY response cannot be performed with respect to the host apparatus. Incidentally, timings B and C in FIG. 5 correspond to the points B and C in FIG. 4, respectively.

Here, even if the host apparatus first sends X_RDY for the next FPDMA command issued from the host apparatus (step S3), the device (the HDD 1) is under the R_RDY response suppressing control, and therefore, cannot make any R_RDY response. In the meantime, the device (the HDD 1) sends X_RDY for SDB FIS transmission irrespective of X_RDY sent from the host apparatus (step S4). The host apparatus determines that X_RDY sent by itself collides, and therefore, stops the X_RDY transmission, thereby making the R_RDY response to X_RDY from the device (the HDD 1) (step S5). The device (the HDD 1) can receive the R_RDY response from the host apparatus to send the SDB FIS (step S6).

In this manner, when the host apparatus issues X_RDY for the next FPDMA command immediately after the completion of the data transfer, the device (the HDD 1) ignores (does not respond to) the X_RDY. The device (the HDD 1) sends X_RDY for sending the SDB FIS immediately after the completion of the data transfer without any influence by the X_RDY from the host apparatus. Consequently, the host apparatus retracts the X_RDY sent by itself, and then, makes the R_RDY response to the X_RDY from the device (the HDD 1), and therefore, the device (the HDD 1) can securely send the SDB FIS, thus completing the command (according to the SATA standard, when the X_RDY from the host apparatus collides with the X_RDY from the device (the HDD 1), the host apparatus retracts the X_RDY).

Incidentally, if the device (the HDD 1) does not make the R_RDY response irrespective of the situation in which the SDB FIS cannot be sent immediately after the completion of the data transfer, the host apparatus can neither issue a command nor issue SRST. Moreover, in the case of an analysis by a SATA bus analyzer or the like, such a phenomenon may be observed that the device (the HDD 1) does not intentionally make any R_RDY response to the X_RDY from the host apparatus. It is undesirable that the device (the HDD 1) indiscriminately suppresses the R_RDY response.

In view of this, the R_RDY response suppressing control signal generator 35 does not produce an R_RDY response suppression control signal and does not output it to the R_RDY response suppresser 41 so as to release the R_RDY response suppression control in the R_RDY response suppresser 41 in the case where it detects COMRESET of a SATA transfer control circuit reset signal that is one of bus reset requests from the host apparatus or SyncEscape for notifying a bus abnormality occurrence from the PHY Layer 21.

In this manner, the device (the HDD 1) can perform the R_RDY response suppression control as long as it can transmit the SDB FIS immediately after the completion of the data transfer. As viewed from the host apparatus (or on the SATA bus), the device (the HDD 1) looks like happening to win in the case where the RegH2D FIS from the host apparatus collides with the SDB FIS from the device (the HDD 1), and therefore, no trouble arises because the device does not look like intentionally making the R_RDY response with respect to the X_RDY from the host apparatus.

Here, although the description has been given of one example of a WRITE FPDMA QUEUED command (receiving and writing the data), the present invention is not limited to this. The same control is applicable to a READ FPDMA QUEUED command (reading and transmitting data).

As described above, the HDD 1 in the present embodiment cannot make any response (an acceptance response to X_RDY) by the R_RDY with respect to X_RDY from the host apparatus (a transmission request made immediately before some FIS sending start including the RegH2D FIS) when the SDB FIS can be securely sent according to the FPDMA command immediately after the completion of the data transfer. As a consequence, the HDD 1 can securely send the SDB FIS immediately after the completion of the data transfer according to the FPDMA command so as to complete the command, and therefore, can reduce exception handling mounted in the FW so as to reduce a processing period of time, thus enhancing processing performance.

Moreover, if the HDD 1 accepts COMRESET from the host apparatus or SyncEscape occurs when it does not make any response by the R_RDY (an acceptance response to the X_RDY), the HDD 1 can release the R_RDY response suppression control. In this manner, the HDD 1 detects a situation requiring operational resetting so as to reset an operation.

When a collision occurs in the related art, there arises a situation in which the device sends the SDB FIS which is retracted as a result of the collision with the RegH2D FIS from the host apparatus, and therefore, the command cannot be completed. In this case, the controller in the device completes the command by the FW, but the processing for operating the HW for completing the command is canceled due to the conflict with the host apparatus, thereby raising a trouble in which it is necessary to perform a complicated processing by an additional HW operation. In contrast, the present embodiment can overcome such a situation.

### Second Embodiment

In the present embodiment, a description will be given of one example of an SSD (Solid State Drive) capable of transmitting and receiving data as a device in SATA. Differences from the first embodiment will be explained below.

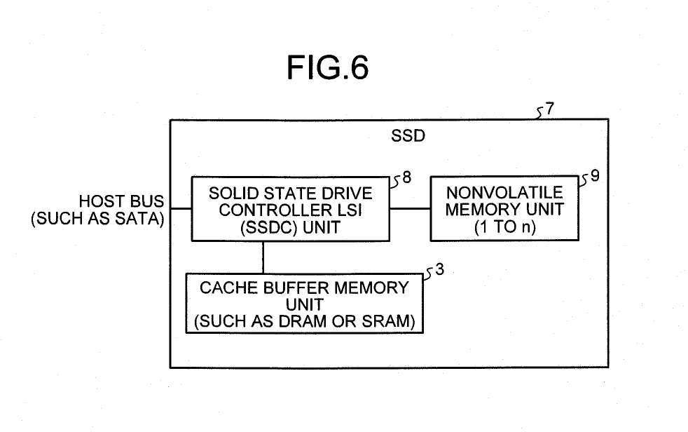

FIG. 6 is a diagram illustrating a constitutional example of the SSD in the second embodiment. An SSD 7 includes an SSD controller LSI (hereinafter referred to as an SSDC) unit 8, a cache buffer memory unit 3, and a nonvolatile memory unit 9.

The SSDC unit 8 is a controller (a control unit) for controlling a device (the SSD 7) and is connected to a host apparatus (not illustrated) via a host bus such as SATA.

The nonvolatile memory unit 9 is a storage unit having a readable/writable data area. Here, it includes n nonvolatile memories.

With respect to the configuration relating to the storage unit, the HDD 1 (see FIG. 1) in the first embodiment and the SSD 7 (see FIG. 6) in the present embodiment are different from each other in that the former includes the head amplifier unit 4, the Read/Write head unit 5, and the record medium unit 6 and in contrast, the latter includes the nonvolatile memory unit 9. However, both of the HDD 1 and the SSD 7 can fulfill the same functions as the device in the SATA.

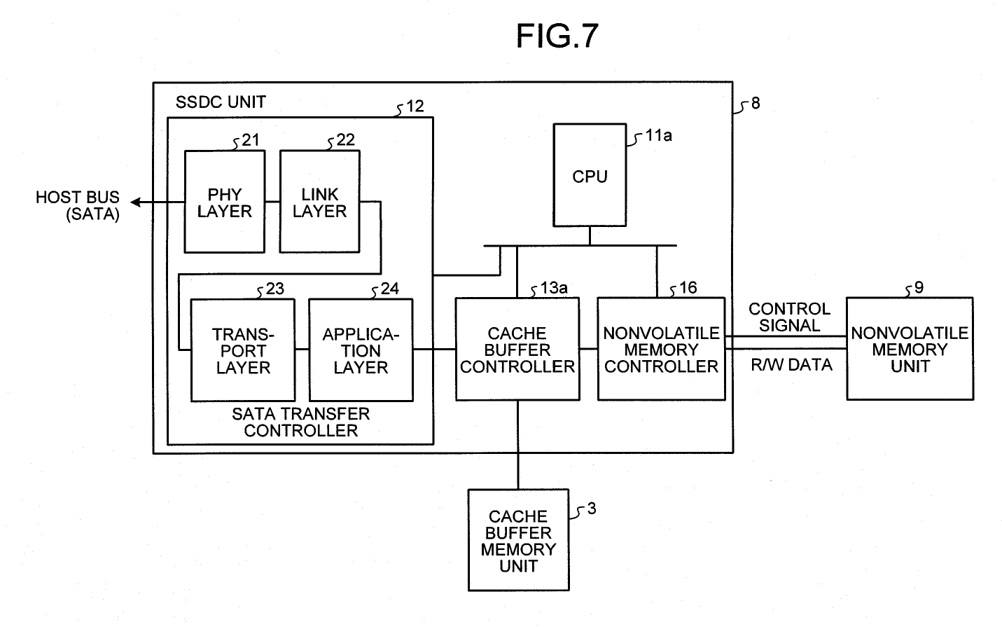

FIG. 7 is a diagram illustrating a constitutional example of the SSDC unit 8 in the second embodiment. The SSDC unit 8 includes a CPU 11a, a SATA transfer controller 12, a cache buffer controller 13a, and a nonvolatile memory controller 16.

The CPU 11a controls the entire SSD 7.

The cache buffer controller 13a controls the cache buffer memory unit 3. Specifically, the cache buffer controller 13a acquires data read by the nonvolatile memory controller 16, and then, stores it in the cache buffer memory unit 3, and further, transfers it to the SATA transfer controller 12.

The nonvolatile memory controller 16 outputs a control signal required for positioning inside of a memory in reading and writing data from or in the nonvolatile memory unit 9, and further, processes Read/Write data for reading and writing data from or in the nonvolatile memory unit 9.

In this manner, even if the configuration of the storage unit provided in the device is changed from the HDD to the SSD, the configuration of the SATA transfer controller 12 is the same. Consequently, the configuration of the storage unit provided in the device is not limited to the HDD. Also in the case of the use of the SSD, the same effects produced in the first embodiment can be obtained.

Although the several embodiments according to the present invention have been described above, they are merely examples, and therefore, they are not intended to restrict the scope of the invention. These novel embodiments may be embodied in other various modes, and further, may be variously omitted, replaced, or modified without departing from the scope of the gist of the invention. These embodiments or modifications are encompassed within the scope or the gist of the invention, and further, within a scope equivalent to that of the invention claimed in claims.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller comprising:
a recognizer configured to recognize that an SDB FIS for completing an FPDMA command being executed can be sent after completion of data transfer executed according to the FPDMA command between a host apparatus and the same;
a signal generator configured to generate and output a control signal for suppressing an R_RDY response with respect to X_RDY received from the host apparatus after the completion of data transfer based on a recognition result by the recognizer;
a suppresser configured to perform an R_RDY response suppression control for suppressing an R_RDY response with respect to X_RDY received from the host apparatus upon receipt of the control signal; and
a sender configured to send an SDB FIS to the host apparatus after the response suppression control.

2. The controller according to claim 1, wherein the signal generator is configured not to generate the control signal when it detects COMRESET output from the host apparatus as a bus reset request or it detects occurrence of a bus abnormal status in the same.

3. The controller according to claim 1, wherein the recognizer is configured to recognize that the SDB FIS can be sent after the completion of the data transfer executed in response to a notification from firmware.

4. The controller according to claim 2, wherein the recognizer is configured to recognize that the SDB FIS can be sent after the completion of the data transfer executed in response to a notification from firmware.

5. A device comprising:
a recognizer configured to recognize that an SDB FIS for completing an FPDMA command being executed can be sent after completion of data transfer executed according to the FPDMA command between a host apparatus and the same;
a signal generator configured to generate and output a control signal for suppressing an R_RDY response with respect to X_RDY received from the host apparatus after the completion of data transfer based on a recognition result by the recognizer;
a suppresser configured to perform an R_RDY response suppression control for suppressing an R_RDY response with respect to X_RDY received from the host apparatus upon receipt of the control signal; and
a sender configured to send an SDB FIS to the host apparatus after the response suppression control.

6. The device according to claim 5, wherein the signal generator is configured not to generate the control signal when it detects COMRESET output from the host apparatus as a bus reset request or it detects occurrence of a bus abnormal status in the same.

7. The device according to claim 5, wherein the recognizer is configured to recognize that the SDB FIS can be sent after the completion of data transfer executed in response to a notification from firmware.

8. The device according to claim 6, wherein the recognizer is configured to recognize that the SDB FIS can be sent after the completion of data transfer executed in response to a notification from firmware.
